(19) United States
(12) Patent Application Publication
(10) Pub. No.: US 2013/0149433 A1
(43) Pub. Date: Jun. 13, 2013

(54) VENEERING CERAMIC FOR DENTAL RESTORATIONS MADE OF YTTRIUM-STABILIZED ZIRCONIUM DIOXIDE AND METHOD FOR APPLYING SAID VENEERING CERAMIC

(71) Applicants: Roland Ehrt, Jena (DE); Martina Johannes, Hermsdorf (DE)

(72) Inventors: Roland Ehrt, Jena (DE); Martina Johannes, Hermsdorf (DE)

(21) Appl. No.: 13/817,526

(22) PCT Filed: Aug. 18, 2011
(86) PCT No.: PCT/DE2011/050026

§ 371 Date: Feb. 18, 2013

(30) Foreign Application Priority Data
Aug. 24, 2010 (DE) 102010035545.3

(51) Int. Cl. C03C 8/02

(52) U.S. Cl. CPC C03C 8/02
USPC 427/2.29; 501/18

(57) ABSTRACT

A veneering ceramic for dental restorations made of yttrium-stabilized zirconium dioxide comprises, in mass percent: SiO₂ 55.0-72.5; Nb₂O₅ 6.0-19.8; B₂O₃ 1.0-9.0; Al₂O₃ 1.2-6.0; Li₂O 5.0-16.5; Na₂O 1.4-11.0; ZrO₂ 0.5-4.0, or comprises: SiO₂ 58.0-68.0; Nb₂O₅ 10.0-19.8; Al₂O₃ 1.2-6.0; Li₂O 8.0-16.5; Na₂O 1.4-8.0; ZrO₂ 0.5-4.0.

The invention is directed to veneering ceramics for dental restorations in which the framework ceramic is made of yttrium-stabilized zirconium dioxide.

The properties of veneering ceramics are determined by the chemical composition, crystalline phases, crystalline structure, and grain of the starting material. The goal is to meet the high mechanical, chemical and aesthetic requirements for veneering ceramics while simultaneously reducing the manufacturing effort for modeling the veneering ceramic.

The prior art for veneering of dental restorations is characterized by leucite-containing dental ceramics. In U.S. Pat. No. 4,798,536, the leucite content is in the range of 35 to 60 mass percent. The flexural strength of the veneering ceramic with leucite crystals is about 80 MPa.

U.S. Pat. No. 4,515,634 suggests the addition of the nucleating agent P₂O₅ to the basic system of Li₂O—CaO—Al₂O₃—SiO₂ in order to improve nucleation and crystallization.

DE 197 25 552 A1 describes alkali silicate glasses for ceramic dental restorations. The dental materials preferably contain apatite crystals. The described apatite glass ceramic is to contain the components CaO:P₂O₅:F in a defined molar ratio of 1:0.02 to 1.5:0.03 to 4.5.

Patent DE 10 2004 013 455 B3 describes apatite glass ceramics based on phosphate-free and fluorine-free siliceous oxyapatites and methods for the production and use thereof In addition to the oxyapatites, leucite can also occur as crystalline phase.

Patent DE 196 47 739 C2 describes a sinterable lithium disilicate glass ceramic and glass. The starting material is sintered to form blanks. These blanks are pressed at 700° C. to 1200° C. to form dental products. The described lithium disilicate glass ceramic shows only a slight reaction to the adjacent casting investment during plastic deformation.

Laid Open Application DE 197 50 794 A1 describes the use of lithium disilicate glass ceramics for use in the hot pressing method. However, it has been shown that application of this method results in insufficient edge strength of the restored tooth and increased tool wear during finishing.

DE 103 36 913 A1 suggests a two-stage fabrication of the tooth to be restored. In the first step, lithium metasilicate is crystallized and is mechanically worked to form dental products. The lithium metasilicate is converted to the stronger lithium disilicate by a second heat treatment.

WO 2008/106958 A2 describes veneering ceramics having high strength and very good adhesion to the yttrium-stabilized zirconium oxide. Aside from lithium disilicate, crystallization of 13 spodumene, lithium metasilicate and various phases of silicon dioxide also results in the described veneering ceramics.

EP 1 235 532 A1 describes a method for producing a high-strength ceramic dental prosthesis based on yttrium-stabilized zirconium dioxide. The framework ceramics produced by this method have 4-point flexural strengths greater than 1200 MPa.

It is the object of the invention to develop a translucent veneering ceramic based on lithium disilicate and a method for applying the veneering ceramic for dental restorations made from yttrium-stabilized zirconium dioxide. This veneering ceramic should not contain leucite, lithium metasilicate or β spodumene and should have very good chemical resistance, excellent adhesion to zirconium dioxide and good surface quality.

According to the invention, this object is met in a veneering ceramic of yttrium-stabilized zirconium dioxide in that it is made from the following components:
a) SiO₂ 55.0-72.5 mass percent
b) Nb₂O₅ 6.0-19.8 mass percent
c) B₂O₃ 1.0-9.0 mass percent
d) Al₂O₃ 1.2-6.0 mass percent
e) Li₂O 5.0-16.5 mass percent
f) Na₂O 1.4-11.0 mass percent g) ZrO₂ 0.5-4.0 mass percent
   and is provided on the surface of the veneering ceramic with a thin glass layer formed during the crystallization.

Lithium disilicate forms the main crystalline phase of the veneering ceramic. It is desirable, but not absolutely necessary, that niobium oxide is also partly crystallized in addition to the lithium disilicate. Niobium oxide is not incorporated in the structure of the lithium disilicate or, if so, only in small amounts. By means of controlled crystallization, niobium-rich phases are enriched in close proximity to the lithium disilicate.

The modification of the phase composition through the crystallization process leads to glass phases with a high niobium oxide content. The niobium oxide-rich glass phases make possible a very high surface quality of the veneering ceramic so that a separate glaze firing is not required.

Coloring compounds or pigments may be added to the veneering ceramic for color matching or fluorescence. The concentration of the individual color components should be at most 3.0 mass percent.

The technology can be modified by adding La₂O₃, BaO, CaO, MgO, ZnO, P₂O₅, TiO₂ and fluoride independently from one another. The total concentration of the additions are in the range of up to 4.0 mass percent at most.

The veneering ceramic has very good adhesion to zirconium dioxide. Therefore, the use of opaquers or liners is not absolutely necessary.

The added starting materials of the veneering ceramic can be applied to the yttrium-stabilized zirconium dioxide as powder by means of coating technique. The powders can also be worked in a defined grinding process to form a slip that can be applied by spraying. After subsequent crystallization, a veneering ceramic with high surface quality is formed.

The veneering ceramic makes it possible to combine the heat treatment in the dental oven with a subsequent laser treatment. To this end, the starting materials of the veneering ceramic which are applied to the framework ceramic are sintered in the dental oven in temperatures ranges of 850° C. to 910° C. and 911° C. to 940° C. The controlled crystallization is carried out in the temperature range of 850° C. to 910° C.; the resulting veneering ceramic has a high surface quality. The veneering ceramic produced in this way can already be used for dental restoration. A local glazing of the veneering ceramic is possible by using a laser in a further process step.

It is also possible that the starting materials of the veneering ceramic are sintered on the framework ceramic in the temperature range of 911° C. to 940° C. and a local crystallization is induced in a further process step by means of laser.

The veneering ceramic can be applied in a plurality of layers. Because of the very good adhesion to zirconium dioxide and the very good surface quality, it is possible that even a sprayed layer is sufficient for the veneering process.

The invention will be described more fully in the following with reference to embodiment examples and drawings. The drawings show:

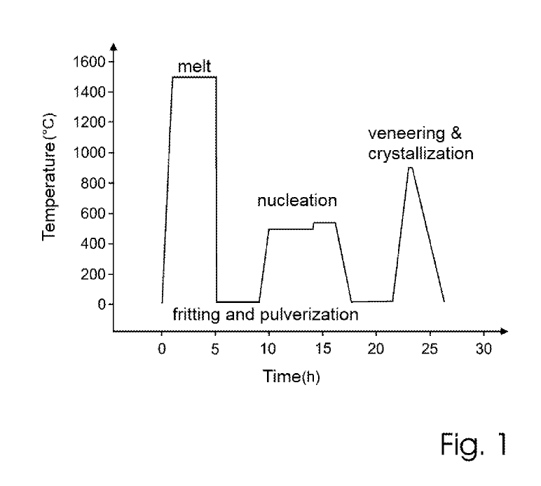

FIG. 1 a possible temperature profile for the production of the veneering ceramic;

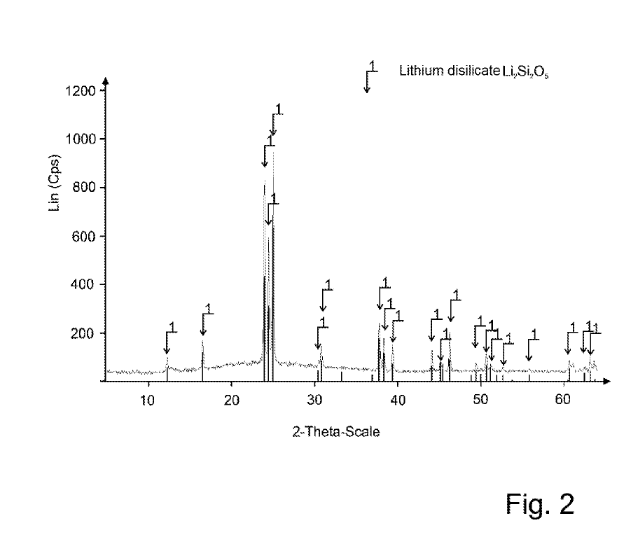

FIG. 2 an x-ray diffractogram (XRD) of the veneering ceramic according to the invention after heat treatment at 900° C.;

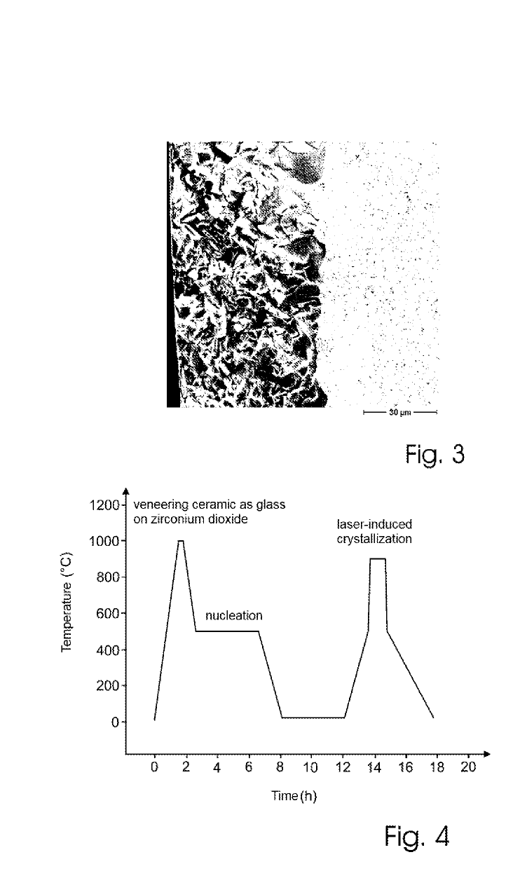

FIG. 3 a microstructure of the veneering ceramic on zirconium dioxide; and

FIG. 4 a temperature profile for the production of the veneering ceramic by laser-induced crystallization.

Typical compositions are shown in the following Table 1.

TABLE 1

| | Examples | | | | | | | | |
|---|---|---|---|---|---|---|---|---|---|
| | 1 | 2 | 3 | 4 | 5 | 6 | 7 | 8 | 9 |
| | mass | mass | mass | mass | mass | mass | mass | mass | mass |
| | % | % | % | % | % | % | % | % | % |
| SiO₂ | 62.5 | 65.6 | 56.2 | 65.4 | 65.5 | 64.5 | 61.5 | 63.8 | 64.2 |
| Nb₂O₅ | 19.0 | 15.4 | 18.2 | 10.8 | 13.1 | 12.1 | 6.7 | 9.9 | 12.8 |
| B₂O₃ | 1.1 | 1.4 | 3.0 | 2.7 | 1.4 | 1.8 | 6.5 | 3.0 | 1.5 |
| Al₂O₃ | 1.4 | 1.5 | 4.3 | 2.5 | 2.0 | 3.0 | 4.7 | 4.0 | 1.9 |
| Li₂O | 13.5 | 13.7 | 5.2 | 11.4 | 12.5 | 11.4 | 6.3 | 9.9 | 12.2 |
| Na₂O | 1.5 | 1.4 | 9.5 | 5.3 | 4.0 | 4.8 | 10.5 | 6.1 | 3.9 |
| ZrO₂ | 1.0 | 1.0 | 3.6 | 1.9 | 1.5 | 1.6 | 3.8 | 2.0 | 1.5 |
| MgO | — | — | — | — | | 0.8 | — | 1.3 | — |
| TiO₂ | — | — | — | — | — | — | — | | 2.0 |
| Total | 100 | 100 | 100 | 100 | 100 | 100 | 100 | 100 | 100 |

Yttrium-stabilized zirconium dioxide is used as framework ceramic for the dental restoration. This can be dyed selectively. In the temperature range from 100° C. to 500° C., the yttrium-stabilized zirconium dioxide has a thermal coefficient of expansion a of 11.1×10⁻⁶/K.

The thermal coefficient of expansion α_{100° C. to 500° C.} for the veneering ceramics described in accordance with the invention is between 9.5×10⁻⁶/K and 11.0×10⁻⁶/K.

The adhesion strength between the yttrium-stabilized zirconium dioxide and the veneering ceramic was determined by the three point flexural test. For this purpose, the powdered veneering ceramic was applied to the end face of two round bars of zirconium dioxide and subjected to the defined heat treatment.

The adhesion strength measured according to the described method should be greater than or equal to 100 MPa.

Chemical resistance was determined in accordance with DIN EN 6872:2009-1ISO and is <50 μg/cm² for the veneering ceramic according to the invention.

Table 2 shows the parameters for the coefficient of expansion α_{100° C. to 500° C.}, adhesion strength and chemical resistance for the compositions in Table 1 for Examples 4 and 5.

TABLE 2

| Parameters | Example 4 | | Example 5 | |
|---|---|---|---|---|
| α_{100°} _{C. to 500°} _{C.} | 10.4 × 10⁻⁶/K | | 10.1 × 10⁻⁶/K | |
| adhesion strength | 148 | MPa | 130 | MPa |
| chemical resistance | 20.3 | μg/cm² | 37 | μg/cm² |

FIG. 1 illustrates a technological sequence for the production of the veneering ceramic. The composition of the starting glasses listed in Table 1 was melted in platinum crucibles or ceramic crucibles at a temperature of 1400° C. and cast in water to produce a frit.

To promote the controlled crystallization, the fitted starting glasses are tempered for approximately 4 hours at 540° C.±50° C. and powdered after cooling. The grain size used ranges from 0.3 μm to 30 μm.

The crystallization of the veneering ceramic begins already at a temperature of 760° C. In addition to lithium disilicate, the crystal phases of lithium metasilicate and cristobalite also occur in the temperature range from 760° C. to 840° C. As the temperature increases, the crystal phases of lithium metasilicate and cristobalite dissolve. The controlled crystallization takes place in the temperature range from 850° C. to 940° C. The x-ray diffractogram (XRD) in FIG. 2 is shown for the crystallization temperature of 900° C.

During crystallization, thin glass layers form at the surface and at the interface with the yttrium-stabilized zirconium dioxide. The thin glass layer at the surface layer is an important quality criterion for the veneering ceramic and allows more efficient processing techniques. In FIG. 3, the microstructure of the veneering ceramic is imaged by scanning electron microscopy.

The veneering ceramic can be applied by brush as a paste and also by spraying. Spraying is preferable for efficient application of thin layers; one or more layers can be sprayed on.

In another procedure, the veneering ceramic is fused to the framework ceramic of yttrium-stabilized zirconium dioxide as transparent glass at a temperature of about 1000° C. In so doing, the fusing of the glass can be carried out in a ceramic oven or through the use of a laser.

The veneering ceramic applied to the yttrium-stabilized zirconium dioxide above the liquidus temperature serves as starting material for a laser-induced crystallization in the veneering ceramic. Through defined use of the laser, it is possible to make the applied layers partially glassy or to subject certain areas to a selective crystallization. FIG. 4 shows a possible sequence for crystallization by means of laser.

1.-9. (canceled)

10. A veneering ceramic for dental restorations, wherein the ceramic comprises yttrium-stabilized zirconium dioxide comprising, in mass percent:
(a) SiO₂ 55.0-72.5
(b) Nb₂O₅ 6.0-19.8
(c) B₂O₃ 1.0-9.0
(d) Al₂O₃ 1.2-6.0
(e) Li₂O 5.0-16.5
f) Na₂O 1.4-11.0
g) ZrO₂ 0.5-4.0.

11. A veneering ceramic for dental restorations, wherein the ceramic comprises yttrium-stabilized zirconium dioxide comprising, in mass percent:
(a) SiO₂ 58.0-68.0
(b) Nb₂O₅ 10.0 -19.8
(c) Al₂O₃ 1.2-6.0
(d) Li₂O 8.0-16.5
(e) Na₂O 1.4-8.0
(f) ZrO2 0.5-4.0.

12. The veneering ceramic of claim 10, wherein the ceramic additionally comprises one or more of TiO₂, La₂O₃, MgO, CaO, ZnO, BaO, P₂O₅, and fluoride, a total concentration of all additional components being not higher than 4.0 mass percent.

13. The veneering ceramic of claim 10, wherein the ceramic further comprises coloring or fluorescing additions selected from one or more of pigments and oxides and fluorides of one or more of Fe, Sn, Ce, Mn, V, Cr, Pr, Tb, Nd, Sm, In, Eu, and Dy.

14. The veneering ceramic of claim 11, wherein the ceramic additionally comprises one or more of TiO₂, La₂O₃, MgO, CaO, ZnO, BaO, P₂O₅, and fluoride, a total concentration of all additional components being not higher than 4.0 mass percent.

15. The veneering ceramic of claim 11, wherein the ceramic further comprises coloring or fluorescing additions selected from one or more of pigments and oxides and fluorides of one or more of Fe, Sn, Ce, Mn, V, Cr, Pr, Tb, Nd, Sm, In, Eu, and Dy.

16. A method of veneering a dental restoration comprising yttrium-stabilized zirconium dioxide with the veneering ceramic of claim 10, wherein the method comprises:
(i) fritting in water a glass melted at 1400° C. to provide a fritted glass;
(ii) tempering the fritted glass for nucleation for from two to six hours at a temperature of from 490° C. to 590° C. to provide tempered glass;
(iii) cooling the tempered glass and thereafter mechanically pulverizing it to a grain size of from 0.3 μm to 30 μm to provide a glass powder;
(iv) converting the glass powder to a paste or a slip and applying it to the dental restoration;
(v) carrying out a heat treatment at from 850° C. to 910° C. to crystallize lithium disilicate;
(vi) enriching niobium oxide-rich phases in close proximity to the lithium disilicate by controlled crystallization to promote formation of a thin glass layer on a surface so that no separate glaze firing is required.

17. The method of claim 16, wherein after (vi) a lithium disilicate crystal phase is melted locally by a laser to increase translucence or transparency of the veneering ceramic.

18. The method of claim 16, wherein the glass powder is converted to a paste or a slip by adding at least one of water and an organic agent.

19. The method of claim 16, wherein the slip is applied by spraying.

20. A method of veneering a dental restoration comprising yttrium-stabilized zirconium dioxide with the veneering ceramic of claim 11, wherein the method comprises:
(i) fritting in water a glass melted at 1400° C. to provide a fritted glass;
(ii) tempering the fritted glass for nucleation for from two to six hours at a temperature of from 490° C. to 590° C. to provide tempered glass;
(iii) cooling the tempered glass and thereafter mechanically pulverizing it to a grain size of from 0.3 μm to 30 μm to provide a glass powder;
(iv) converting the glass powder to a paste or a slip and applying it to the dental restoration;
(v) carrying out a heat treatment at from 850° C. to 910° C. to crystallize lithium disilicate;
(vi) enriching niobium oxide-rich phases in close proximity to the lithium disilicate by controlled crystallization to promote formation of a thin glass layer on a surface so that no separate glaze firing is required.

21. The method of claim 20, wherein after (vi) a lithium disilicate crystal phase is melted locally by a laser to increase translucence or transparency of the veneering ceramic.

22. The method of claim 20, wherein the glass powder is converted to a paste or a slip by adding at least one of water and an organic agent.

23. The method of claim 20, wherein the slip is applied by spraying.

24. A method of veneering a dental restoration comprising yttrium-stabilized zirconium dioxide with the veneering ceramic of claim 10, wherein the method comprises:
(i) fritting in water a glass melted at 1400° C. to provide a fritted glass;
(ii) tempering the fritted glass for nucleation for from two to six hours at a temperature of from 490° C. to 590° C. to provide a tempered glass;
(iii) cooling the tempered glass and thereafter mechanically pulverizing it to a grain size of from 0.3 μm to 30 μm to provide a glass powder;
(iv) converting the glass powder to a paste or a slip and applying it to the dental restoration;
(v) carrying out a heat treatment in a range of from 911° C. to 940° C., and inducing a lithium disilicate crystal phase by laser.

25. The method of claim 24, wherein the glass powder is converted to a paste or a slip by adding at least one of water and an organic agent.

26. The method of claim 24, wherein the slip is applied by spraying.

27. A method of veneering a dental restoration comprising yttrium-stabilized zirconium dioxide with the veneering ceramic of claim 11, wherein the method comprises:
(i) fritting in water a glass melted at 1400° C. to provide a fritted glass;
(ii) tempering the fritted glass for nucleation for from two to six hours at a temperature of from 490° C. to 590° C. to provide a tempered glass;
(iii) cooling the tempered glass and thereafter mechanically pulverizing it to a grain size of from 0.3 μm to 30 μm to provide a glass powder;
(iv) converting the glass powder to a paste or a slip and applying it to the dental restoration;
(v) carrying out a heat treatment in a range of from 911° C. to 940° C., and inducing a lithium disilicate crystal phase by laser.

28. The method of claim 27, wherein the glass powder is converted to a paste or a slip by adding at least one of water and an organic agent.

29. The method of claim 27, wherein the slip is applied by spraying.
